(19) United States
(12) Patent Application Publication
(10) Pub. No.: US 2015/0040212 A1
(43) Pub. Date: Feb. 5, 2015

(54) LOCKING APPARATUS WITH ENHANCED SECURITY USING IRIS IMAGE

(71) Applicants: Dae-hoon Kim, Seoul (KR); Hyeong-in Choi, Seoul (KR); Nam-Sook Wee, Seoul (KR); Doo-Seok Lee, Seoul (KR); Jung-Kyo Sohn, Seoul (KR)

(72) Inventors: Dae-hoon Kim, Seoul (KR); Hyeong-in Choi, Seoul (KR); Nam-Sook Wee, Seoul (KR); Doo-Seok Lee, Seoul (KR); Jung-Kyo Sohn, Seoul (KR)

(21) Appl. No.: 14/356,564

(22) PCT Filed: Nov. 16, 2011
(86) PCT No.: PCT/KR2011/008754

§ 371 Date: Oct. 27, 2014

(30) Foreign Application Priority Data
Nov. 8, 2011 (KR) 10-2011-0115856

(51) Int. Cl. G06F 21/32; G06K 9/00

(52) U.S. Cl. CPC G06F 21/32; G06K 9/00617
USPC 726/19

(57) ABSTRACT

The present invention relates to a locking apparatus with enhanced security using an iris image, wherein, if a terminal including a short-range wireless communication means and camera accesses the locking apparatus, the locking apparatus: transmits, a token comprising at least one of identification number and/or random number of the locking apparatus from a token generator mounted on the locking apparatus, to the terminal; requests an iris image be photographed and transmitted within a preset time period; generates an iris template from the iris image photographed by a camera fixed on the user terminal; encrypts and transmits the generated iris template and the token from the terminal to the locking apparatus using short-range wireless communication; and performs at least one of access permission (lock release), access denial (a maintenance of a locked state), a request for re-photographing, and an emergency alarm by decrypting the received encrypted iris template and token using a decoder mounted on the locking apparatus, and comparing the similarity thereof with an iris template registered and stored in a database in advance.

### TECHNICAL FIELD

The present invention relates to a locking apparatus having enhanced security using an iris image, wherein when a terminal including short-range wireless communication means and a camera accesses the locking apparatus, the locking apparatus transmits a token, including one or more of the identification number and/or random number of the locking apparatus from a token generator mounted on the locking apparatus, to the terminal, requests that an iris image be captured and transmitted within a set time, generates an iris template from the iris image captured by the camera fixed to the user terminal, encrypts and transmits the generated iris template and the token from the terminal to the locking apparatus using short-range wireless communication, decrypts the received encrypted iris template and token using a decryptor mounted on the locking apparatus, compares similarity between the decrypted iris template and token with an iris template and token previously registered with and stored in a database, and performs one or more of access permission (lock release), access denial (a maintenance of a locked state), a request for re-photographing, and an emergency alarm.

### BACKGROUND ART

A conventional locking apparatus is driven by the pressing of a number key, a registered key, etc., but is problematic in security if a number is lost, a key is lost, etc. with respect to a third party.

Furthermore, the recognition of a fingerprint is also used in the locking apparatus, but there are problems in that there is a good possibility that a device error may occur depending on an environment in which the locking apparatus is exposed and security is low because it is difficult to check whether a fingerprint is the fingerprint of a living person at a point of time at which the person registered with a list of visitors requests entrance.

If a camera for photographing the iris is directly installed in the conventional locking apparatus, there are problems in that the volume of the locking apparatus is increased, it is difficult for users to have their irises photographed because the location where the locking apparatus is installed is low, and the locking apparatus is not practical because dust or alien substances are accumulated or the camera is exposed to excessive light due to the camera exposed to an external environment where the locking apparatus has been installed, leading to problems in photographing.

### DISCLOSURE

### Technical Problem

An object of the present invention is to enhance the security of a locking apparatus by encrypting information based on the iris template of a living person at a point of time at which the entrance of the person registered with and stored in a list of visitors stored in the database of the locking apparatus is permitted and using the encrypted information in authentication in order to enhance the security of security method and means of an existing locking apparatus.

Another object of the present invention is to enhance the security of a locking apparatus, including means capable of short-range wireless communication, such as a Near Field Communication (NFC) chip, in order to bi-directionally exchange pieces of information between the locking apparatus and a terminal for generating an iris template wirelessly, encrypting and decrypting all data transmitted upon communication using an encryptor and a decryptor, and using the encrypted and decrypted data for authentication.

Yet another object of the present invention is to enhance security by selecting and applying one or more of the ID of a terminal, the location where photographing has occurred, the time when the photographing has occurred, and a random number received from a locking apparatus in order to provide validity information for an iris image to the locking apparatus and sending the validity information to the locking apparatus.

Further yet another object of the present invention is to enhance the locking apparatus configured to give an emergency alarm by adding information indicative of an enforced situation when an iris image is generated under coercion of other persons to iris template generation information when the iris is photographed.

### Technical Solution

A technical solution of the present invention is to provide a locking apparatus having enhanced security using an iris image, including means for registering and storing information about a visitor for authentication in the locking apparatus with and in a terminal in which short-range wireless communication means and a camera are attached and installed, means for sending information about the user of the terminal and terminal tag information from the terminal to the locking apparatus for authentication as the locking apparatus is activated when the terminal is brought close to the locking apparatus, means for checking whether the visitor is an authenticated visitor by searching for information about the visitor registered and stored in the database of the locking apparatus based on the tag information received from the locking apparatus, means for capturing an iris image within a set time in the terminal if the visitor is determined to be an authenticated visitor, generating a token, and sending the token to the locking apparatus, and means for generating an iris template from the iris image obtained by the camera fixedly installed at the terminal, bringing the terminal close to the locking apparatus in order to send the generated iris template and token to the locking apparatus through short-range wireless communication, determining similarity between the iris template and token received from the terminal with an iris template registered and stored in the locking apparatus by comparing the received iris template and token with the registered and stored iris template and simultaneously determining whether photographing has been performed within the set time, and performing one or more of lock release, the maintenance of a locked state, a request for re-photographing, and an emergency alarm.

Another technical solution of the present invention is to provide a locking apparatus having enhanced security. In order to provide the locking apparatus with information about the validity of an iris image that is used to increase security, the terminal includes means for providing the validity information to the locking apparatus by selecting and applying one or more of pieces of information, such as the ID of the terminal, the location where photographing has occurred, a point of time at which photographing was generated, and a random number received from the locking apparatus.

Yet another technical solution of the present invention is to provide a locking apparatus having enhanced security, wherein a specially fragile digital watermark is inserted and included in an iris image in order to increase security and an attempt is made to tamper the iris image, the inserted digital watermark is configured to be broken, and the locking apparatus is configured to recognize the validity of an iris image if the digital watermark is properly extracted from the received iris image and is configured to determine that the iris image has been tampered if the digital watermark is not properly extracted and restrict entrance.

### Advantageous Effects

The present invention has an advantageous effect in that it can enhance the security of a locking apparatus by encrypting information based on the iris template of a living person at a point of time at which the entrance of the person registered with and stored in a list of visitors stored in the database of the locking apparatus is permitted and using the encrypted information in authentication in order to enhance the security of security method and means of an existing locking apparatus.

Another effect of the present invention is to enhance the security of a locking apparatus, including means capable of short-range wireless communication, such as an NFC chip, in order to bi-directionally exchange pieces of information between the locking apparatus and a terminal for generating an iris template wirelessly, encrypting and decrypting all data transmitted upon communication using an encryptor and a decryptor, and using the encrypted and decrypted data for authentication.

Yet another effect of the present invention is to enhance security by selecting and applying one or more of the ID of a terminal, the location where photographing has occurred, the time when the photographing has occurred, and a random number received from a locking apparatus in order to provide validity information for an iris image to the locking apparatus and sending the validity information to the locking apparatus.

Further yet another effect of the present invention is to enhance the locking apparatus configured to give an emergency alarm by adding information indicative of an enforced situation when an iris image is generated under coercion of other persons to iris template generation information when the iris is photographed.

### DESCRIPTION OF DRAWINGS

FIG. 1 shows the general construction of a locking apparatus having enhanced security using an iris image in accordance with the present invention.

FIG. 2 schematically shows an example of the construction of a terminal in accordance with the present invention.

FIG. 3 schematically shows an example of the construction of the locking apparatus including a door lock in accordance with the present invention.

<Description of reference numerals of principal elements in
the drawings>

| | |
|---|---|
| 11: terminal | 12: locking apparatus |
| 13: user of terminal | 14: host |
| 21: terminal | 22: photographing unit or camera |
| 23: quality measurement unit | 24: pre-processor |
| 25: template generator | 26: encryptor |

27: short-range wireless communication module

| | |
|---|---|
| 31: door lock or locking apparatus | 32: token generator |
| 33: decryptor | 34: matching unit |
| 35: database | 36: locking apparatus controller |
| 37: short-range wireless | 38: user interface |
| communication | |

### BEST MODEL

A technical solution of the present invention is to provide a locking apparatus having enhanced security using an iris image, including means for registering and storing information about a visitor for authentication in the locking apparatus with and in a terminal in which short-range wireless communication means and a camera are attached and installed, means for sending information about the user of the terminal and terminal tag information from the terminal to the locking apparatus for authentication as the locking apparatus is activated when the terminal is brought close to the locking apparatus, means for checking whether the visitor is an authenticated visitor by searching for information about the visitor registered and stored in the database of the locking apparatus based on the tag information received from the locking apparatus, means for capturing an iris image within a set time in the terminal if the visitor is determined to be an authenticated visitor, generating a token, and sending the token to the locking apparatus, and means for generating an iris template from the iris image obtained by the camera fixedly installed at the terminal, bringing the terminal close to the locking apparatus in order to send the generated iris template and token to the locking apparatus through short-range wireless communication, determining similarity between the iris template and token received from the terminal with an iris template registered and stored in the locking apparatus by comparing the received iris template and token with the registered and stored iris template and simultaneously determining whether photographing has been performed within the set time, and performing one or more of lock release, the maintenance of a locked state, a request for re-photographing, and an emergency alarm.

### MODE FOR INVENTION

Detailed embodiments of the present invention are described with reference to the accompanying drawings.

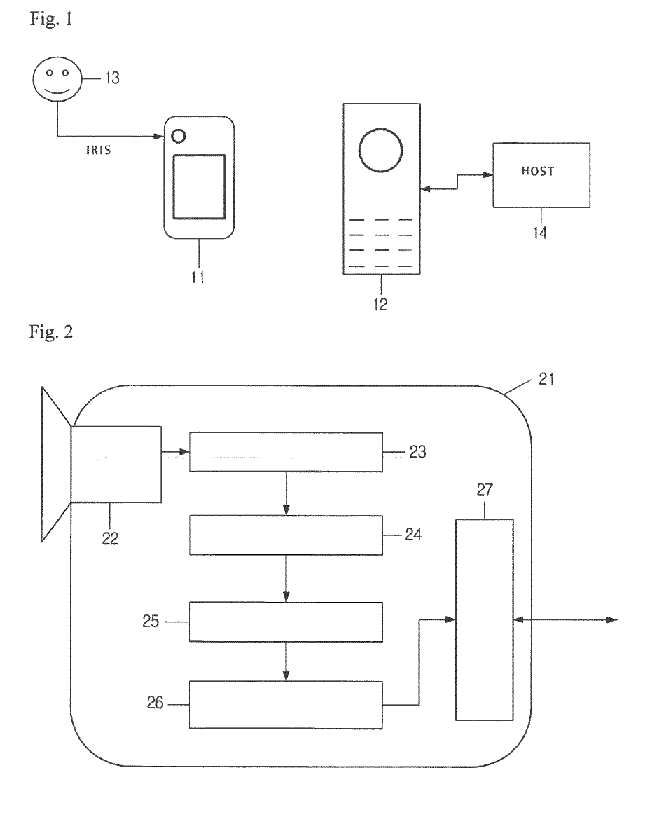

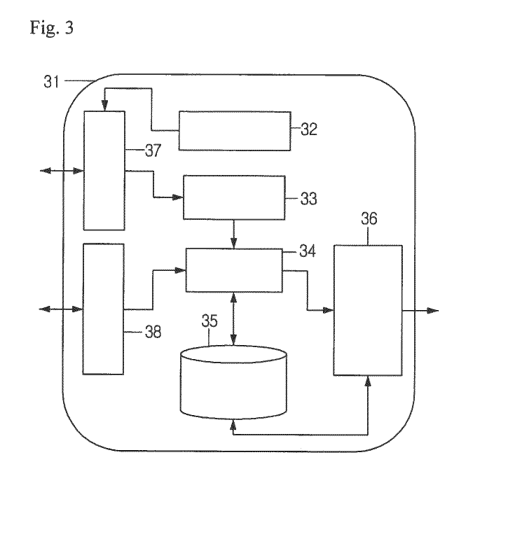

FIG. 1 shows the general construction of a locking apparatus having enhanced security using an image of the iris (hereinafter referred to as a ‘iris image’) in accordance with the present invention. FIG. 2 schematically shows an example of the construction of a terminal in accordance with the present invention. FIG. 3 schematically shows an example of the construction of the locking apparatus including a door lock in accordance with the present invention.

In the locking apparatus having enhanced security using an iris image according to the present invention, the locking apparatus including a door lock and a terminal are configured to operate in conjunction with each other, and the locking apparatus is locked and the locking of the locking apparatus is released using information about the user of the terminal and/or tag information related to the terminal and an iris image of the user through the terminal.

In order to increase the security of a locking apparatus, if a camera for photographing the iris is directly installed at a locking apparatus including a door lock (hereinafter referred to as a ‘locking apparatus’) so as to use an iris image of a visitor, there are problems in that it is difficult for users to have their irises naturally photographed, the camera installed at the locking apparatus is likely to be exposed to an external environment and to be damaged, and it is not practical because problems in photographing are likely to occur due to dust or fifth accumulated on a surface of the lens or excessive light exposure.

In order to solve the problems, the present invention provides a locking apparatus having high security, configured to capture and obtain an iris image of a user through a mobile device and/or a terminal (hereinafter referred to as a ‘terminal’) to which various types of cameras are attached and installed and to release the locking apparatus or maintain the locking of the locking apparatus.

In FIG. 1, a user is the owner of a terminal and is a person who tries to release the locking apparatus and attempts entrance.

In FIG. 1, the terminal may be any device capable of photographing the iris and sending an image of the photographed iris to the locking apparatus through short-range wireless communication. In the present invention, the terminal may be a handheld phone or a smart phone, for example.

That is, the terminal described in the present invention has only to be a device or apparatus to which a camera can be attached and which can exchange data capable of locking or releasing the locking apparatus through short-range wireless communication.

The locking apparatus is configured to transmit and receive iris images, pieces of tag information, and tokens through short-range wireless communication (27 of FIG. 2) bi-directionally, determine whether a user is a user who has been registered and stored in the database or memory of the locking apparatus and who has been permitted for entrance based on the iris image, the tag information, and the token, and control entrance by controlling the locking apparatus through a locking apparatus controller based on the determined information.

Alternatively, if the locking apparatus does not have sufficient computing power, the locking apparatus may be configured so that control of entrance other than short-range communication is performed by a host (14 of FIG. 1) as in FIG. 1.

If the terminal includes a display unit, a photographing unit (hereinafter referred to as a ‘camera’) is preferably installed on the same face as the display unit. More preferably, in order to facilitate photographing, the camera may be placed over the display unit. The lens of the camera may have a size of 1 cm or less.

The photographing unit of the present invention has only to be an image sensor capable of obtaining the characteristic information of an iris image that is used for security.

The short-range wireless communication (27 of FIG. 2) is preferably configured to perform data transmission and reception within a very close distance (within 10 cm), such as Near Field Communication (NFC). The reason why the distance is limited as described is that a third party is prevented from cutting in between the terminal and the locking apparatus that perform wireless communication.

A Near Field Communication (NFC) chip for the short-range wireless communication is embedded in each of the terminal and the locking apparatus. The NFC chip is configured to release locking or maintain locking when the terminal (11 of FIG. 1) and the locking apparatus (12 of FIG. 1) exchange pieces of required information bi-directionally.

When a user has his or her iris captured by the camera (22 of FIG. 2) of the terminal, the user may check that the iris is captured through a display unit by his or her eye. Accordingly, this may help to obtain an iris image having good quality, but photographing is possible even without the display unit.

If the iris is photographed at the place where the terminal is used and illuminance is low, a recognition ratio may be low because the clearness of an image of the photographed iris is low. In accordance with the present invention, a lighting unit capable of providing weak flash (white light or infrared rays) to the extent that an eye is not stimulated right before photographing in order to assist photographing may be fixed to one side of a face where the camera of the terminal has been installed.

Furthermore, the lighting unit may include a function or means capable of instructing a user on a behavior through sound or an LED so that an iris image of the user can be captured more clearly.

The camera is preferably configured using a CCD or CMOS capable of capturing an image of a mega pixel or more.

An encryptor inserts a token or key into an iris image in response to a request from the locking apparatus or performs encryption or signature on information about an iris image.

A quality measurement unit determines whether a captured image satisfies a predetermined quality criterion. If a predetermined quality criterion is satisfied, the quality measurement unit transmits the captured iris image to a pre-processor.

The following is for enhancing the security of the locking apparatus in accordance with the present invention, and one of important elements is that a user determines the validity of an iris image transferred by the terminal.

In the present invention, in order to prevent an iris image that has been used in a previous entrance attempt or has been intentionally tampered from being used in a current entrance attempt, the locking apparatus includes means for analyzing and determining whether an iris image is effective before performing a matching task on the iris image transmitted by the terminal. If it is determined that the iris image is not effective, the means may request the terminal to capture an iris image again or may deny the entrance of a visitor and maintain locking.

In the present invention, information that authenticates the validity of an iris image transmitted by the terminal includes information about whether the image is an iris image of a visitor in that section, at the place designated by the camera attached to the terminal, and at that point of time.

The terminal needs to include means capable of selecting one or more of the ID of the terminal, the location where photographing has occurred, a point of time at which photographing has occurred, and a random number received from the locking apparatus and of providing one or more of them to the locking apparatus as information for authenticating validity.

The information for authenticating validity may be used to determine to be the iris template of a living person that has been directly photographed by a user using the camera at a point of time at which entrance is selectively permitted.

The ID of the terminal means not only the ID of the terminal itself, but also the ID of the camera (image sensor) attached to the terminal in order to capture an iris image. The locking apparatus determines that an iris image has been captured by a registered terminal based on the ID of the terminal or the ID of the camera.

The location where photographing has occurred means an absolute location or a relative location when the terminal captures an iris image. For example, absolute location information includes information provided by a GPS.

In order to obtain this type of information, means capable of operating in conjunction with a GPS is mounted on the terminal.

For example, the relative location information includes the ID of a base station or a wireless AP to which the terminal has been connected. In order to obtain this type of information, means capable of being connected to a base station or a wireless AP is mounted on the terminal. In the present invention, the means may be used to verify the validity of location information.

The locking apparatus determines whether the location where photographing has occurred, received from the terminal, is present in a range set and stored in memory, determines that the photographing has occurred at that location if, as a result of the determination, the location is present in the range set and stored in memory, and determines that the location has been photographed at another location if, as a result of the determination, the location is not in the range set and stored in the memory and that the location is information not having validity.

A timer is mounted on the terminal in order to obtain information about a point of time at which photographing has been generated by the camera mounted on the terminal. If the timer is not mounted on the terminal that operates in conjunction with the locking apparatus, the terminal may receive information about a current time from a base station, a wireless AP, etc. to which the terminal has been connected, and may provide the received information to the locking apparatus. The locking apparatus determines whether a point of time at which photographing has been generated, received from the terminal, is present in a range set and stored in the memory, determines that the photographing has been generated in the time zone if, as a result of the determination, the point of time is present in the range, and determines that the point of time is information not having validity if, as a result of the determination, the point of time is not present in the range and that the photographing has been generated in another time zone.

The information about the random number received from the locking apparatus is generated by the locking apparatus in a token form in a process of requesting, by the locking apparatus, an iris image from the terminal and is transmitted to the terminal. The terminal is configured to transmit the received random number to the locking apparatus along with the iris image.

One or more of the pieces of information for validating the validity of an iris image in the terminal may be configured so that they are inserted into the iris image at point of time at which the iris image is captured.

If the information for verifying validity is inserted into and included in an iris image, the information may be inserted in a digital watermark form so that it can be easily extracted.

A digital watermark inserted into an iris image is configured in software so that it is broken if an attempt is made to alter the iris image by inserting an especially fragile digital watermark into the iris image.

When a digital watermark is correctly extracted from an iris image, the locking apparatus verifies the validity of the iris image based on the digital watermark. If a digital watermark is not extracted, the locking apparatus determines that the iris image has been tampered and thus maintains a locked state.

For security, it is preferred that a digital watermark be protected in hardware from external intrusion so that a process of inserting the digital watermark is not drained from the terminal.

The pre-processor extracts only the iris from a captured iris image so that an iris template can be generated. The pre-processor may be omitted.

The locking apparatus and the terminal include the encryptor and the decryptor in order to enhance security, and they are configured to encrypt and transmit data when performing bidirectional communication, if necessary. The side that has received the encrypted data is configured to decrypt and use the encrypted data.

The protection of information is described below.

An iris image and pieces of information used in transmission and reception procedures are encrypted in order to handle the drain of information or a potential danger that may occur due to tampering resulting from the drain of information in a process of generating and transmitting and receiving information in the terminal or the locking apparatus.

Furthermore, an authentication process for proving that both the terminal and the locking apparatus are the true subjects of transmission and reception. In the present invention, any method may be used if the method is for authentication or information encryption.

It is preferred that the terminal be equipped with a function for determining an imitation eye in order to prevent a third party not the user of the terminal from photographing the imitation eye using the terminal without permission and from deceiving as if the imitation eye is a photograph iris of a real person. The method of determining an imitation eye may use the technical element used in determining the availability of information, or may use a method of storing, by a user, a plurality of images of a background screen that may be obtained when capturing an iris image at the place where the locking apparatus in memory and determining whether a captured iris image corresponds to an imitation eye by comparing the captured iris image with the stored images.

Information about the validity of an iris image may be intentionally tampered within the terminal and then transferred to the locking apparatus.

If malicious code is stealthily installed on the terminal, the malicious code may intervene in a process of capturing an iris image and transferring the image to the locking apparatus without authority, may directly tamper the iris image or information about the validity of the iris image, and may transmit the tampered image or information.

In order to prevent the drain or tampering of information due to such malicious code, it is preferred that a hardware or software design be performed so that an application of the terminal is prevented from accessing a process of capturing an iris image, generating validity information, and sending the validity information to the locking apparatus.

If an iris image is sought to be generated under coercion of another person, a button for inputting information indicative of the enforced situation before photographing may be further included so that the information indicative of the enforced situation is added to iris template generation information when photographing the iris and the locking apparatus may generate an emergency alarm.

A technical element for registering an iris template with the database of the locking apparatus is described below.

Information about the user of the terminal and tag information related to the terminal are read from the database in which information about the visitors of the locking apparatus is stored through the short-range wireless communication of the locking apparatus so that the user may release the locking apparatus or maintain locking using the terminal.

Whether or not the information about the user of the terminal and the tag information related to the terminal, read through the short-range wireless communication, are information previously registered in the terminal is checked in the database or memory of the locking apparatus. If, as a result of the check, the information about the user and the tag information of the terminal have been registered, a message indicative that they have already been registered is transmitted to the terminal.

When information about the user and tag information of the terminal are registered, the information about the user and the tag information may be registered using a button for registration included in the locking apparatus, or the information about the user and the tag information may be registered according to a procedure for registration using a program installed on the terminal.

If information about the user and tag information of the terminal are not stored in the database of the locking apparatus, the information about the user of the terminal and the tag information of the terminal may be stored in the database or memory of the locking apparatus, and a procedure to be described later may be performed in order to register the iris template of a user of the terminal.

More specifically, the tag information may be configured using one or more of the ID (a resident registration number, etc.) of a user of the terminal, the ID of the terminal, and a One Time Password (OTP).

The locking apparatus is configured to include a token generator and is configured to transmit a token, generated by the token generator, to the terminal through the NFC chip of the locking apparatus through the short-range wireless communication.

The terminal receives the token from the locking apparatus through the short-range wireless communication and obtains an iris image of the user of the terminal when the user of the terminal has the iris photographed using the camera attached to the terminal.

The iris image received through the camera attached to the user terminal may experience means for checking whether the captured iris image satisfies a quality criterion necessary to recognize the iris through the quality measurement unit.

The quality criterion includes means for evaluating and determining a path in order to determine whether the iris image has been directly received from the camera or has been received through another path.

The means may be formed using the information used to determine whether an iris image is effective.

If, as a result of the determination, the iris image has been received through another path, the locking apparatus is configured to insert error information into data to be transmitted to the terminal, transfer the error information through the short-range wireless communication, capture an iris image using the camera attached to the user terminal, and transmit the captured image.

The quality criterion for an iris image may include self-quality evaluation criterion information that includes the clearness, occlusion, etc. of the iris image that are necessary to generate an iris template.

If the clearness of an iris image captured by the camera is a reference or lower set and stored in the memory or the occlusion thereof is a preset reference or lower, error information is inserted into data to be transmitted to the locking apparatus. In such a case, the terminal transmits a message to a user so that the user has his or her iris image captured again.

If the captured iris image satisfies the quality criterion of the quality measurement unit, the pre-processor performs a pre-processing task for generating an iris template.

If error information is included in the data transmitted by the terminal or the data transmitted by the terminal is not information within a set time, error processing is performed, and error information is transmitted to the terminal so that a registration procedure is performed again.

The iris templates of users that have been previously registered are stored in the database of the locking apparatus. The locking apparatus includes a matching unit for determining whether to release locking or maintain locking by comparing an iris image received through the terminal with the registered and stored iris templates.

The matching unit determines whether to release locking or maintain locking by determining similarity between the iris templates of users previously registered and stored in the database of the locking apparatus and an iris template transmitted by the decryptor of the locking apparatus. If data matched with the already registered iris template of the user has been registered and stored in the database, the user terminal that has attempted registration is informed that registration has been performed, and new registration is not performed.

If there is no matched data, terminal information and iris template of a new user are registered and stored in the database or memory of the locking apparatus, and new registration is terminated.

An iris template, information about the user of the terminal, and information about the terminal used when new registration or additional registration is used may be registered and stored using information already stored in the memory.

The locking apparatus includes means capable of deleting a person that is not required from visitors who have been registered and stored in the database or the memory.

The means for deletion may be configured using a deletion button installed in the main body of the locking apparatus or may be configured to operate in conjunction with the terminal or a computer.

The means of the user terminal for releasing or maintaining the locking apparatus through the short-range wireless communication using the camera after a procedure of registering a visitor with the memory or the database of the locking apparatus is described below.

First, a user may press the entrance number of the locking apparatus using a keypad, and the locking apparatus may deny the entrance if the input number of the keypad is wrong.

The user brings the user terminal close to the locking apparatus so that they perform short-range wireless communication.

Information about the user of the terminal and tag information related to the terminal are transmitted to the locking apparatus through the short-range wireless communication, thereby activating the locking apparatus and the terminal in operation for lock release or locking maintenance.

The database of the locking apparatus is searched in order to check whether the transmitted tag information is registered information about the terminal. If, as a result of the check, the transmitted tag information is found to not have been registered, a process is no longer performed or an alarm “the terminal not registered” may be transmitted to the terminal through voice or a message.

If the locking apparatus determines that the received tag information is the registered information about the terminal, the locking apparatus transmits a token generated by the token generator to the terminal through the short-range wireless communication of the locking apparatus.

The terminal receives the token through the short-range wireless communication and obtains an iris image by capturing the image using the camera attached to the user terminal.

The locking apparatus may include means for transferring the iris image captured by the camera to the quality measurement unit and checking whether the iris image satisfies the quality criterion of a captured iris image.

An element for measuring the quality of the iris image captured by the camera and checking whether the captured image satisfies the quality criterion is the same as that described in the above registration procedure, and thus a description thereof is omitted.

The iris template generator mounted on the terminal generates the iris template of an iris image from the iris image obtained by the camera fixed to the terminal.

The iris template generator is configured in software and mounted on the memory of the terminal.

The iris template is described in more detail later.

The decryptor of the locking apparatus decrypts data encrypted and transmitted by the terminal and extracts error information, warning information, information indicating whether the data has been obtained within a set time from the time when the token was transferred, user information, and the iris template.

If error information is included in the data and the data is not information obtained within the set time, the locking apparatus transmits error information to the terminal. If warning information is included in the data, the locking apparatus transmits an alarm message.

The matching unit is mounted on the memory of the locking apparatus. The matching unit of the locking apparatus determines similarity between the iris template of the user previously registered and stored in the database and the iris template decrypted and transferred by the decryptor. A result of the comparison of the similarity is stored in the database or the memory.

If the iris template of the user previously registered and stored in the database is not matched with the iris template decrypted and transferred by the decryptor, the locking apparatus maintains locking and does not permit entrance.

If the iris template of the user previously registered and stored in the database is matched with the iris template decrypted and transferred by the decryptor, the locking apparatus controller transmits a signal indicative of the release of locking, the locking is released, and the entrance of the user is permitted.

The token generator, the encryptor, the decryptor, the iris template matching unit, and the iris template generator are configured so that they are automatically mounted on the memory when downloading software in accordance with the present invention.

The encryptor, the decryptor, the iris template the matching unit, and the iris template generator have already disclosed in the invention of the applicant or are known technical elements that have been widely used, and a detailed description thereof is omitted.

Each of the locking apparatus and the terminal in accordance with the present invention includes the memory or a Universal Subscriber Identity Module (USIM) chip. One or more of an iris template, a Personal Identification Number (PIN), the ID of the terminal, and personal information for security are registered and stored in the database or the memory. When the terminal is made bring close to the locking apparatus, the memory and the USIM chip are activated, transmit the user of the terminal and tag information related to the terminal to the locking apparatus. The locking apparatus determines that the terminal is an authenticated visitor registered and stored in the database or memory of the locking apparatus based on the received tag information, generates a token, and transmits the token to the terminal.

If it is determined that the terminal is an authenticated terminal registered and stored in the memory or database of the locking apparatus based on the information about the user of the terminal and the tag information related to the terminal, the locking apparatus generates a token and transmits the token to the terminal. The terminal includes means for capturing an iris image using the camera installed in the terminal within a set time and requesting that the iris template and the token be transmitted to the locking apparatus.

The USIM chip includes all pieces of information for identifying a user, and the USIM chip may be adopted and used both in the terminal and the locking apparatus.

That is, the USIM chip may store information about a visitor that is used to determine whether the user of the terminal is an authenticated visitor and an iris template that is compared with an iris template obtained by the terminal from a captured iris image.

Means for generating an iris template from an iris image captured by the camera installed in the terminal and generating encrypted iris template information using the generated iris template through the encryptor is included.

The iris template is an iris image format stored in the memory that is used to determine similarity between iris images and to perform the similarity of the iris image. The iris template includes biometric characteristics unique to a person, but a memory capacity for storing the iris template is relatively smaller than that of the original iris image captured by the camera.

For example, if a memory capacity occupied by the original iris image is about 100 Kbyte, a corresponding iris template is a memory capacity of about 10 Kbyte, which is about 1/20 of the original iris image data.

This means that the iris template is further smaller than the original iris image data.

Biometric characteristics unique to a person, obtained by processing the iris image using Fourier transform or wavelet transform, are stored in the iris template in order to increase processing speed upon authentication and to reduce a memory capacity upon storage.

The terminal includes means for bringing the terminal close to the locking apparatus in order to transmit the encrypted iris template and token generated in the terminal through the short-range wireless communication.

The locking apparatus includes means for decrypting the encrypted iris template and token received from the terminal through the short-range wireless communication using the decryptor.

The locking apparatus includes means for determining similarity between the decrypted iris template and token and an iris template that has been previously registered and stored in the database or memory of the locking apparatus or that has been registered and stored in the database or memory of the locking apparatus through a registration procedure, releasing locking and permitting entrance or maintaining locking and denying entrance based on a result of the determination, and performing one or more of a request for re-photographing and an emergency alarm.

The token generator of the locking apparatus generates the token and transmits the token to the terminal. The token is used to determine whether an iris template and token obtained by photographing using the camera of the terminal has been photographed within a set time and transmitted.

The means, that is, technical elements for achieving the present invention, may be changed in their order and omitted if they may be changed and omitted.

The means for encryption and decryption using the aforementioned encryptor and decryptor may also be omitted, if necessary.

It is preferred that the iris templates stored in the terminal and the locking apparatus be fabricated and mounted on a technical element capable of increasing security in hardware and/or software so that the iris template is not externally read.

An iris image obtained using the camera attached to the terminal is encrypted with a small memory capacity including biometric characteristics unique to a person and is transmitted to the locking apparatus. It is preferred that the transmitted iris template be decrypted and compared with an iris template stored in the memory or the database.

In order to increase security, it is preferred that an algorithm for determining similarity by comparing the iris template obtained by photographing using the camera with the iris template registered and stored in the terminal be implemented on the memory of the locking apparatus.

Meanwhile, any widely known algorithm may be used as the algorithm for measuring similarity between the iris templates.

For example, similarity between the iris templates may be defined as a Euclidian distance between coefficient sequences obtained by performing Fourier transform or wavelet transform on all of or some regions of iris images (iris texture).

If similarity between an iris template obtained by the camera fixed to and installed in the terminal and an iris template stored in the locking apparatus is a reference value or more that has been set and stored in the memory, authentication is established and the locking apparatus is released. If the similarity is less than the set and stored reference value, the locking apparatus maintains a locked state without change.

The meaning that the similarity is the reference value or more means that similarity is present and the locking apparatus is released. The meaning that the similarity is less than the reference value means that similarity is low and the locking apparatus remains locked.

The encryptor and the decryptor are configured in software, and an encryption or decryption program designed and fabricated using a common encryption or decryption algorithm may be mounted on the terminal and the locking apparatus.

When the lock release of the locking apparatus is completed, it is preferred that the iris template be discarded so that it is not drained by a hacker or the iris template be changed into another form so that the original iris template cannot be deduced.

Active mode of the terminal of the present invention is described based on the aforementioned technical elements.

1. The locking apparatus and the terminal are activated through the short-range communication, and the locking apparatus checks that the terminal is a registered terminal through the aforementioned technical elements.

2. If the terminal is a registered terminal, the locking apparatus transmits token information including the ID of the locking apparatus to the terminal through the short-range communication.

3. The terminal analyzes the data received through the short-range communication, checks the ID of the locking apparatus, and instructs the iris to be photographed by displaying the instruction on the display unit of the terminal or through voice.

4. The terminal on which software for performing iris photographing in accordance with the present invention is mounted performs iris photographing when a hardware button installed on one side of the terminal or a software button on a screen of the terminal is pressed.

The activation of the terminal by the locking apparatus in accordance with the present invention is described below.

1. The locking apparatus and the terminal are activated through the short-range communication, and the locking apparatus checks that the terminal is a registered terminal through the aforementioned technical elements.

2. If the terminal is a registered terminal, the locking apparatus transmits token information including the ID of the locking apparatus to the terminal through the short-range communication.

3. The terminal analyzes the data obtained through the short-range communication and determines whether an authenticated user is a user registered and stored in the memory by performing search and comparison on the data.

4. If it is determined that the user is an authenticated user, the terminal performs iris photographing according to a predetermined procedure. In this case, the user has only to perform the iris photographing in response to an instruction from the terminal.

In the activation of the terminal and the locking apparatus, when a user attempts the lock release of the locking apparatus using a proximity sensor, a photosensor, etc. on one side of the locking apparatus, an element that enables the locking apparatus to recognize the attempt and the terminal to perform the aforementioned lock release procedure is sufficient.

A locking method having enhanced security using an iris image using the locking apparatus having enhanced security using an iris image in accordance with the present invention also falls within the scope of the present invention if the technical elements of the locking method are the same as those of the locking apparatus having enhanced security using an iris image or have been changed from those of the locking apparatus.

### INDUSTRIAL APPLICABILITY

The present invention provides the locking apparatus having enhanced security using an iris image, wherein when the terminal including the short-range wireless communication means and the camera accesses the locking apparatus, the locking apparatus transmits a token, including one or more of the identification number and/or random number of the locking apparatus from the token generator mounted on the locking apparatus, to the terminal, requests that an iris image be captured and transmitted within a set time, generates an iris template from the iris image captured by the camera fixed to the user terminal, encrypts and transmits the generated iris template and the token from the terminal to the locking apparatus using the short-range wireless communication, decrypts the received encrypted iris template and token using the decryptor mounted on the locking apparatus, compares similarity between the decrypted iris template and token with an iris template and token previously registered with and stored in the database, and performs one or more of access permission (lock release), access denial (a maintenance of a locked state), a request for re-photographing, and an emergency alarm. Accordingly, industrial availability is very high because security and reliability are greatly improved.

1. A locking apparatus having enhanced security using an iris image, comprising:
short-range wireless communication means for transmitting and receiving information for authentication to the locking apparatus and a terminal;
means for registering and storing information about a visitor in a database or memory of the locking apparatus;
means for sending an Iris image obtained by a camera fixedly installed at the terminal or an iris template generated from the iris image to the locking apparatus through short-range wireless communication; and
means for determining similarity between the iris image received from the terminal or an iris template generated from the received iris image and an iris image registered with the locking apparatus or an iris template generated from the registered iris image and for performing one or more of lock release, a maintenance of a locked state, a request for re-photographing, and an emergency alarm based on a result of the determination.

2. The locking apparatus of claim 1, further comprising:
means for previously registering and storing information about the terminal in the database or memory of the locking apparatus along with the information about the visitor; and
means for determining whether the terminal is an authenticated terminal through short-range wireless communication with the terminal.

3. The locking apparatus of claim 1, wherein the short-range wireless communication is configured to perform two-way communication between the terminal and the locking apparatus each of which has a Near Field Communication (NFC) chip embedded therein.

4. The locking apparatus of claim 1, wherein:
before the terminal sends the iris template to the locking apparatus, the locking apparatus sends a token to the terminal, and
the token comprises one or more of an ID number and/or random number of the locking apparatus generated by a token generator mounted on the locking apparatus.

5. The locking apparatus of claim 4, wherein:
the terminal sends one or more of the ID number and/or random number of the locking apparatus, included in the token, to the locking apparatus when the terminal sends the iris template to the locking apparatus, and
the locking apparatus checks whether the ID number and/or random number included in the token are identical with an ID number and/or random number included in the locking apparatus and generate an error message if, as a result of the check, the ID number and/or random number included in the token are not identical with the ID number and/or random number included in the locking apparatus.

6. The locking apparatus of claim 2, wherein the means for determining whether the terminal is an authenticated terminal selects and configures one or more of an ID of the terminal, a personal ID, and an OTP and sends the one or more of the ID of the terminal, personal ID, and OTP to the locking apparatus.

7. The locking apparatus of claim 1, wherein one or more of a digital watermark and encryption for increasing security when pieces of information are exchanged between the terminal and the locking apparatus are selected and applied to the short-range wireless communication.

8. The locking apparatus of claim 1, wherein when the terminal sends the iris template to the locking apparatus, the terminal includes one or more of information about a time when the iris image is captured by the camera and information about a place where the iris image is captured in the iris template and sends the iris template.

9. The locking apparatus of claim 8, wherein one or more of the information about the time and the information about the place included in the iris template are inserted in a fragile digital watermark form in order to enhance security.

10. The locking apparatus of claim 8, wherein:
when the information about the time is received from the terminal, the locking apparatus determines whether the information about the time when the iris image is captured exceeds a time limit set in the locking apparatus by comparing the information about the time when the iris image is captured with a time when the token is generated and sends error information to the terminal if, as a result of the comparison, the received the information about the time is found to exceed a time set in the locking apparatus, and
when the information about the place is received from the terminal, the locking apparatus determines whether the information about the place exceeds a location range set in the locking apparatus and sends error information to the terminal if the received information about the place is found to exceed the location range set in the locking apparatus.

11. The locking apparatus of claim 10, wherein the location information comprises absolute location information using GPS information provided to the terminal or relative location information from a base station or wireless AP to which the terminal is connected.

12. The locking apparatus of claim 1, wherein the terminal further comprises means for checking the liveness detection of visitor's iris by comparing with backgrounds of the captured iris image.

13. The locking apparatus of claim 1, wherein:
the locking apparatus registers additional information about a new visitor by using a button installed at the locking apparatus or performs a procedure for registration using a program installed on the terminal, and
the locking apparatus further comprises means for photographing an iris of the new visitor using the camera fixedly installed at the terminal and for registering and storing the information about the new visitor in the database or memory of the locking apparatus.

14. The locking apparatus of claim 1, wherein:
the locking apparatus measures similarity that is an Euclidian distance of coefficient sequences, obtained by performing Fourier transform or wavelet transform on part of or an entire region of an iris image, between an iris template obtained by the camera fixedly installed in the terminal and an iris template stored in the locking apparatus, and
the locking apparatus is released when authentication is established if the similarity exceeds a reference value stored in the memory and maintains its locked state if the similarity does not exceed the reference value.

15. The locking apparatus of claim 14, wherein the locking apparatus uses a deletion button installed in the locking apparatus or means configured to operate in conjunction with the terminal or a computer in order to delete information about a visitor previously registered and stored in the database or memory of the locking apparatus if the visitor is not valid.

16. The locking apparatus of claim 1, wherein the terminal comprises a lighting unit configured to be adjacent to the camera and to obtain a clear iris image.

17. The locking apparatus of claim 1,
wherein the camera is installed in the same direction with a display unit at the terminal in order to easily check an iris of a user and photograph the iris of the user.

18. The locking apparatus of claim 1, wherein:
the terminal further comprises a button for inputting information indicative of the enforced situation when the iris is photographed under coercion of other persons before the iris is photographed; and
the locking apparatus generates an emergency alarm when the information indicative of the enforced situation is added to the generated iris template information.

19. The locking apparatus of claim 1, wherein the terminal comprises a hardware button or software button which is fixedly installed at the terminal and pressed the button by an user, in order to release the locking apparatus when the terminal captures an iris image of the user.

20. The locking apparatus of claim 1, wherein when photographing mode in the terminal is activated by the locking apparatus, the terminal is configured to be activated by the locking apparatus through short-range wireless communication.

21. The locking apparatus of claim 1, wherein the terminal is a handheld phone or smart phone carried by users.

22. The locking apparatus of claim 1, wherein the terminal comprises a quality measurement unit for measuring quality of the iris image by applying and determining one or more of degree of clearness and occlusion of the iris image obtained by the camera.

23. The locking apparatus of claim 1, wherein the terminal further comprises a pre-processor for extracting only the iris image from images captured by the camera.
